(19) United States
(12) Patent Application Publication
(10) Pub. No.: US 2013/0160643 A1
(43) Pub. Date: Jun. 27, 2013

(54) SELF CLEANING SORBENT INJECTION LANCE

(71) Applicant: Herman W. PILATS, Pittsburgh, PA (US)

(72) Inventor: Herman W. PILATS, Pittsburgh, PA (US)

(73) Assignee: AMEREX ENVIRONMENTAL TECHNOLOGIES, INC., Batawia, IL (US)

(21) Appl. No.: 13/334,456

(22) Filed: Dec. 22, 2011

(51) Int. Cl. B01D 53/06; F16K 31/02; B01D 46/46

(52) U.S. Cl. 95/23; 96/109; 96/110; 95/26; 251/129.01

(57) ABSTRACT

A self-cleaning sorbent injection lance includes a lance arm, a lance outlet connected to a sorbent arm, a sorbent inlet connected to the lance arm, an air control valve connected to the lance arm, and a electrical valve control connected to the air control valve. The sorbent inlet provides sorbent material passing through the lance arm. The electrical valve control opens the air control valve when receiving an electrical signal, so that compressed air is supplied to the injection lance for cleaning sorbent material clogged in the lance arm and lance outlet without taking the self-cleaning sorbent injection lance off-line.

### TECHNICAL FIELD

The technical field is devices and equipment, particularly lances, for injecting material, particularly sorbent materials, into gas streams.

### BACKGROUND

Present environmental regulations require that combustion processes such as coal fired boilers, waste-to-energy plants, biomass boilers, incinerators and other such combustion equipment control acid gas emissions. Acid gas emissions are emitted acidic elements such as sulfur dioxide, sulfur trioxide, hydrochloric acid, hydrogen fluoride, and similar others, produced from the combustion of materials such as coal, waste materials biomass products, etc.

The technology presently employed to control acid gas emissions includes injecting appropriate dry sorbent materials that react efficiently with these elements where injected into the gas stream. The sorbent materials react and neutralize the acid compounds to allow them to be removed later by filters installed downstream, such as fabric filters (baghouses). Typical sorbent materials used are calcium oxide, calcium hydroxide, sodium bicarbonate, sodium sesquicarbonate and other similar products.

To achieve efficient removal of acid gas constituents, the sorbent materials are introduced into the flue gas stream through multiple lances that uniformly dispense the sorbent evenly across the entire gas stream to promote uniform mixing between the sorbent and the acid gas elements. Removal efficiency is decreased when lances are blocked by the sorbent or by the resulting reaction compounds. Such reaction compounds are formed at the lance's tip when the sorbent reacts with the acid gas elements and forms various neutralization compounds. As a result, lances must be frequently inspected for blockages, manually serviced (removed) to be cleaned and then reinstalled. The lack of spray lances in the duct area being serviced also has an adverse effect on the emission control efficiency.

Other systems that utilize lances to inject materials into gas streams may suffer from similar blocking, whether from the material itself or reaction compounds firmed by the material and the gas stream.

### SUMMARY

Embodiments described herein have numerous advantages, including overcoming the defects of the prior art described above. These advantages may be achieved by a self-cleaning sorbent injection lance. The lance includes a lance arm, through which sorbent material passes, a lance outlet, connected to sorbent arm, through which sorbent material is output from the self-cleaning sorbent injection lance, in which lance arm and lance outlet may get clogged with sorbent material while in operation, a sorbent inlet, connected to the lance arm, that provides sorbent material to the self-cleaning sorbent injection lance, an air control valve, connected to the lance arm, through which compressed air may be supplied to the self-cleaning sorbent injection lance for cleaning clogged sorbent material and an electrical valve control, connected to the air control valve, that opens the air control valve when receiving an electrical signal so that compressed air is supplied to lance arm and lance outlet of self-cleaning sorbent injection lance whereby the self-cleaning sorbent injection lance may be cleaned and sorbent material clogs removed. without taking the self-cleaning sorbent injection lance off-line.

These advantages may also be achieved by a system utilizing a self-cleaning sorbent injection lance for injecting sorbent into a flue gas duct. The system may include a flue gas duct, through which flue gas flows, one or more self-cleaning sorbent injection lances, each lance including a lance arm, through which sorbent material passes, a lance outlet, connected to sorbent arm, through which sorbent material is output from the self-cleaning sorbent injection lance, in which the lance arm and lance outlet may get clogged with sorbent material while in operation, a sorbent inlet, connected to the lance arm, that provides sorbent material to the self-cleaning sorbent injection lance, an air control valve, connected to the lance arm, through which compressed air may be supplied to the self-cleaning sorbent injection lance for cleaning clogged sorbent material, and a electrical valve control, connected to the air control valve, that opens the air control valve when receiving an electrical signal so that compressed air is supplied to lance arm and lance outlet of self-cleaning sorbent injection lance whereby the self-cleaning sorbent injection lance may be cleaned and sorbent material clogs removed without taking the self-cleaning sorbent injection lance off-line. The system also includes a compressed air supply, connected to the air control valve and a control computer, in which the control computer activates the compressed air-supply and opens the air control valve to provide compressed air to the one or more self-cleaning sorbent injection lances.

These advantages may also be achieved by a method for operating a self-cleaning sorbent injection lance for injecting sorbent into a flue gas duct. The method supplies sorbent material to a self-cleaning sorbent injection lance, determines whether to operate self-cleaning on scheduled or as-needed basis, if operating on scheduled basis, determines if scheduled time has elapsed, if elapsed, opens air control valve to supply compressed air to the self-cleaning sorbent injection lance for cleaning clogged sorbent material in the self-cleaning lance, if operating on an as-needed basis, determines whether flow-rate of sorbent material through self-cleaning sorbent injection lance has dropped below pre-determined level, if flow-rate has dropped below pre-determined level, opens air control valve to supply compressed air to the self-cleaning sorbent injection lance for cleaning clogged sorbent material in the self-cleaning lance, closes air control valve when flow-rate reaches pre-determined level, and repeats above steps.

### BRIEF DESCRIPTION OF THE DRAWINGS

The detailed description may refer to the following drawings, wherein like numerals refer to like elements, and wherein:

FIG. 1 is diagram of an embodiment of a self-cleaning sorbent injection lance installed into a flue gas duct.

FIG. 2 is a flowchart illustrating an embodiment of a method of operating a self-cleaning sorbent injection lance.

FIG. 3 is a block diagram illustrating a system incorporating an embodiment of a self-cleaning sorbent injection lance installed into a flue gas duct.

### DETAILED DESCRIPTION

Described herein are embodiments of a self-cleaning sorbent injection lance, Embodiments may be used in air pollution control (APC) systems where dry sorbent powders are introduced into a flue gas stream exhausted from combustion equipment, such as boilers, incinerators, thermal oxidizers, and other similar equipment. Sorbent injection is employed to neutralize and remove acid gas constituents, such as sulfur dioxide, sulfur trioxide, hydrochloric acid vapor, hydrogen fluoride, and other acidic elements contained in exhaust gas streams as required by environmental control agencies.

Additionally, embodiments of the new self-cleaning sorbent injection lance may also be applied to other APC systems where powdered activated carbon is injected into the flue gas stream to absorb and remove mercury, dioxins, furans and other volatile organic substances (VOC's). There are still other uses of embodiments of the self-cleaning sorbent injection lance, as is apparent to one of ordinary skill in the art.

Present technology for dry sorbent injection lances consists of installing pressure gauges and/or pressure switches that indicate when lances are blocked. When gauges are used, an operator must be assigned to frequently obtain gauge readings and promptly service lances when they are found to be blocked. When pressure switches are used, they generate a required-service alarm at, e.g., a control panel display and also require prompt attention of plant personnel to inspect and service blocked lances.

Embodiments of the new self-cleaning sorbent injection lance provide self-cleaning features in which the sorbent injection lance is automatically cleared by briefly introducing compressed air or inert gas through the lance, thereby purging it clean. In embodiments, the lance cleaning cycle may be conducted manually by an operator or automatically, e.g., through the APC control system. In embodiments, the on-line lance cleaning time is very brief, normally less than one (1) second, every few hours. Consequently, the on-line lance cleaning does not material affect APC system operating efficiency. Additionally, sorbent dispersion in the APC system by having all operating lances clear of any blockages.

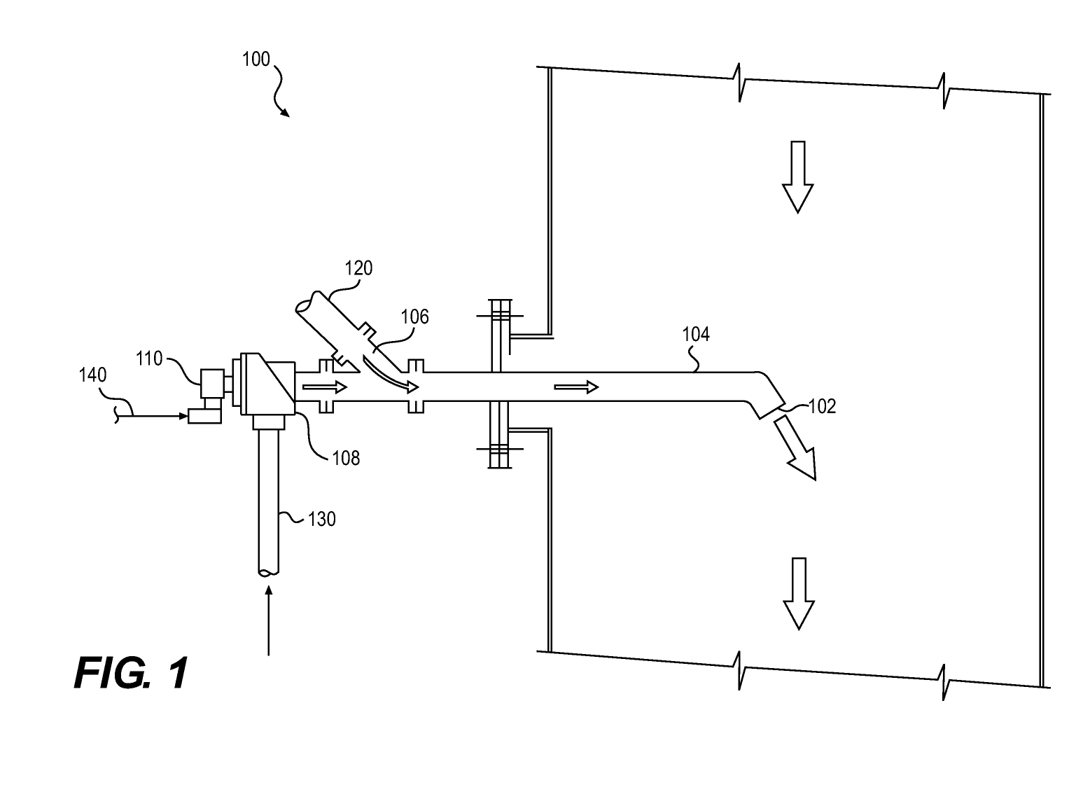

With reference now to FIG. 1, shown is an embodiment of the self-cleaning sorbent injection lance 100. This new lance design is self-cleaning. In the embodiment shown, through the use of pressure switches, the lance operating pressure is constantly monitored. When a pressure set-point is reached, the lance is automatically cleaned, e.g., by a control system. Lance 100 cleaning may be performed by briefly opening, e.g., a solenoid operated diaphragm air valve and introducing high pressure air or gas (normally 80 to 100 PSIG for less than one (1) second) to clear the lance of any blockages. Should the lance pressure remain high, the control system may repeat this cleaning process until the pressure returns to normal.

Additionally, in embodiments, this cleaning process may be conducted on a timed basis in which the sorbent injection lances are periodically cleaned, one at a time in a sequence, to ensure the lances remain clear of any blockages.

With continuing reference to FIG. 1, embodiment of self-cleaning sorbent injection lance 100 includes lance outlet 102, lance arm 104, sorbent powder inlet 106, air control valve 108, and electrical valve control 110. As shown, lance outlet 102 and lance arm 104 may be designed so that lance outlet 102 faces generally downward in the direction of the flue gas flow. The lance arm 104 may be bent at an approximately forty-five degree angle as shown. Alternatively, lance arm 104 may be bent at an angle closer to perpendicular (e.g., ˜45-90 degrees). For some applications, lance outlet 102 and lance arm 104 may be designed so that lance outlet 102 faces in opposite direction, generally upwards into the gas flow. Lance outlet 102 will generally be a simple, wide opening.

Sorbent powder is introduced into lance arm 104 for output through lance outlet 102 through sorbent powder inlet 106. Sorbent powder inlet 106 is typically connected to a sorbent powder feed 120, e.g., from pneumatic conveying blowers (not shown). The sorbent powder feed 120 may include piping or other conveyances that connect sorbent powder inlet 106 to pneumatic conveying blowers. Other mechanisms for conveying sorbent powder to sorbent powder inlet 106, as are known to those of ordinary skill in the art, may be used. Likewise, if injection lance 100 is used to inject material other than sorbent powder, inlet 106 may be connected to the other material supply.

Sorbent powder inlet 106 may also include a shut-off valve (not shown). When self-cleaning process of self-cleaning sorbent injection lance 100 is activated, shut-off valve of sorbent powder inlet 106 may be closed to shut down flow of sorbent powder through sorbent powder inlet 106 into lance arm 104. Electrical valve control 110, which is used to control air control valve 108, may also control shut-off valve of sorbent powder inlet 106. Alternatively, an additional electrical or other type of control may control shut-off valve. Likewise, in embodiment of inlet 106 that does not include shut-off valve, supply of sorbent powder (e.g., pneumatic conveying blowers) may simply be shut down during self-cleaning process. Alternatively, sorbent powder supply may continue to be provided to lance 100 during self-cleaning process.

With continuing reference to FIG. 1, air control valve 108 controls supply of compressed air, e.g,, from compressed air supply 130, to self-cleaning sorbent injection lance 100. In embodiments, compressed air is supplied to self-cleaning sorbent injection lance 100 through air control valve 108 in order to clean lance 100. Specifically, air control valve 108 may be opened to allowed compressed air to pass through valve 108 into lance arm 104 and out through lance outlet 102. Compressed air should be under sufficient pressure so that force of compressed air is sufficient to dislodge any blockages in lance arm 104 or lance outlet 102. Compressed air supply may be an air compressor or other supply of compressed air known to those of ordinary skill in the art.

Air control valve 108 may be any type of valve that is electronically controlled and that is sufficient to close supply of compressed air. For example, air control valve 108 may be a diaphragm-type air control valve 108 that is controlled by an electric solenoid. Accordingly, electrical valve control 110 may be an electric solenoid connected to an electrical supply. When electrical supply provides electricity to electric solenoid, electric solenoid opens air control valve 108, allowing compressed air to enter self-cleaning sorbent injection lance 100. In an embodiment, electrical supply also provides electricity to electric solenoid (not shown) connected to sorbent inlet to shut sorbent inlet 106 as described above.

Electrical supply 140 may be connected to a system control computer that activates and de-activates electrical supply 140 (e.g., sends electrical signal to operate solenoid). Control computer may activate electrical supply 140, operating solenoid to open air control valve 108 on a periodic, scheduled basis to clean out self-cleaning sorbent injection lance 100. Alternatively, systems control computer may constantly measures the flow of sorbent material through self-cleaning sorbent injection lance 100 (sensors—not shown—may be installed in lance arm 104, at lance outlet 102 or just outside lance outlet 102 to provide a measurement of the flow-rate of the sorbent material through lance 100). If control computer detects that sorbent material flow-rate falls below a certain, pre-determined level, control computer may send a signal and activate electrical supply 140, providing electricity to electric solenoid, opening air control valve 108. When sensors indicate that flow-rate of sorbent material has returned to above pre-determined level, control computer may de-activate electrical supply 140, removing electricity from electric solenoid and causing air control valve 108 to close. Alternatively, control computer may cause air control valve 108 to be opened, and compressed air supplied, for a pre-determined amount of time, at the end of which, sorbent material supply is resumed (see above) and the flow-rate is measured. If the flow-rate is not above the pre-determined level, control computer may re-activate electrical supply, operating solenoid to re-open air control valve 108 and re-supply compressed air to self-cleaning sorbent injection lance 100. Other modes of operation may be implemented by those of skill in the art.

Control computer may also control sorbent inlet 106 as described above, causing it to shut when lance 100 is in cleaning mode and open otherwise. Alternatively, control computer may shut down sorbent supply at sorbent source, e.g., by shutting down pneumatic conveying blowers. However, sorbent supply and sorbent inlet 106 may remain on and open during cleaning.

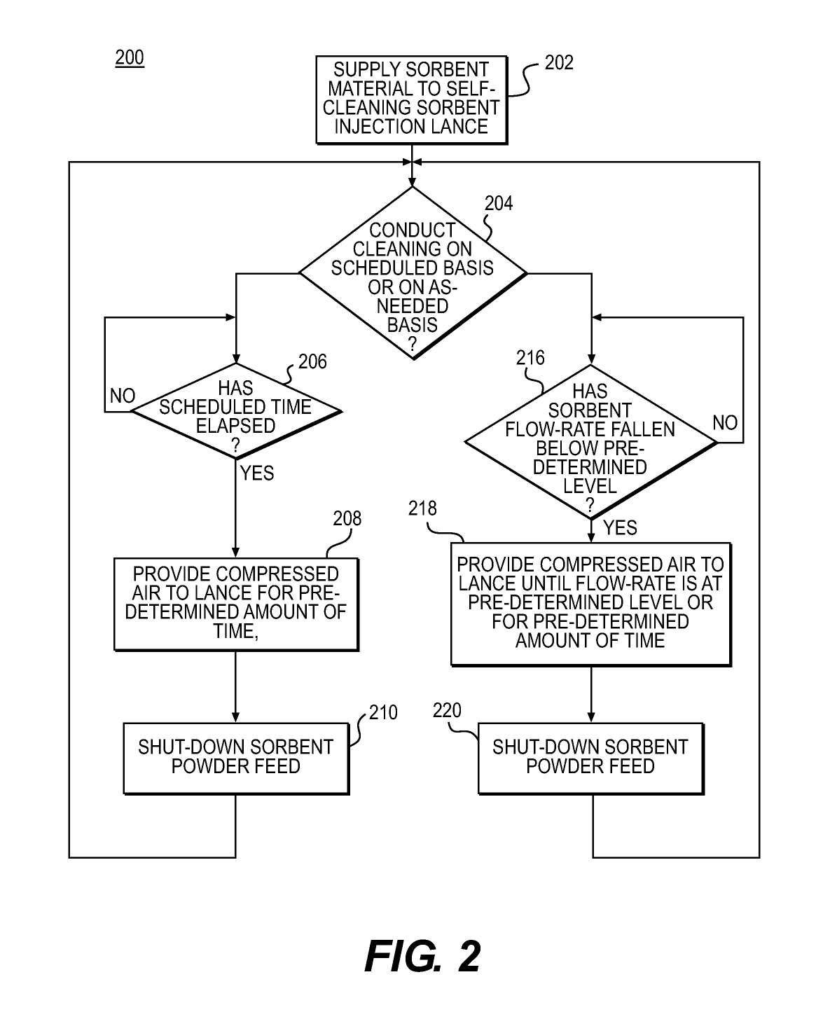

With reference now to FIG. 2, shown is a flowchart illustrating an embodiment of method 200 of operation of self-cleaning sorbent injection lance 100. Method 200 supplies sorbent material to self-cleaning sorbent injection lance 100, block 202. Control computer system may determine whether to conduct cleaning on scheduled basis or on as-needed (e.g., measured) basis, block 204. Control computer may make determination 204 based on operator input. If operating on scheduled basis, method 200 determines if scheduled time has elapsed, block 206, and if elapsed, opens air control valve (e.g., by activating electrical supply and sending signal to solenoid), providing compressed air to lance 100 for pre-determined amount of time, block 208. Method 200 may shut-down sorbent powder feed prior to or contemporaneously with self-cleaning, block 210. If scheduled time has not elapsed, method 200 continues to monitor the time until elapsed.

If operating on as-needed basis, control computer may determine if sorbent flow-rate has fallen below pre-determined level (e.g., which may be set in control computer by operator or based on programmed determination of sufficient rate needed to provide acid gas removal)), block 216. If sorbent flow-rate has not fallen below pre-determined level, method 200 continues to monitor flow-rate until it does. If sorbent flow-rate has fallen below pre-determined level, method 200 opens air control valve (e.g., by activating electrical supply and sending signal to solenoid), providing compressed air to lance 100 until flow-rate is at pre-determined level or for pre-determined amount of time, block 218. Method 200 may shut-down sorbent powder feed prior to or contemporaneously with self-cleaning, block 220. As described above, method 200 may activate compressed air supply for pre-determined amount of time, re-measure flow-rate, and then re-activate compressed air, and repeat this process until flow-rate meets or exceeds desired level.

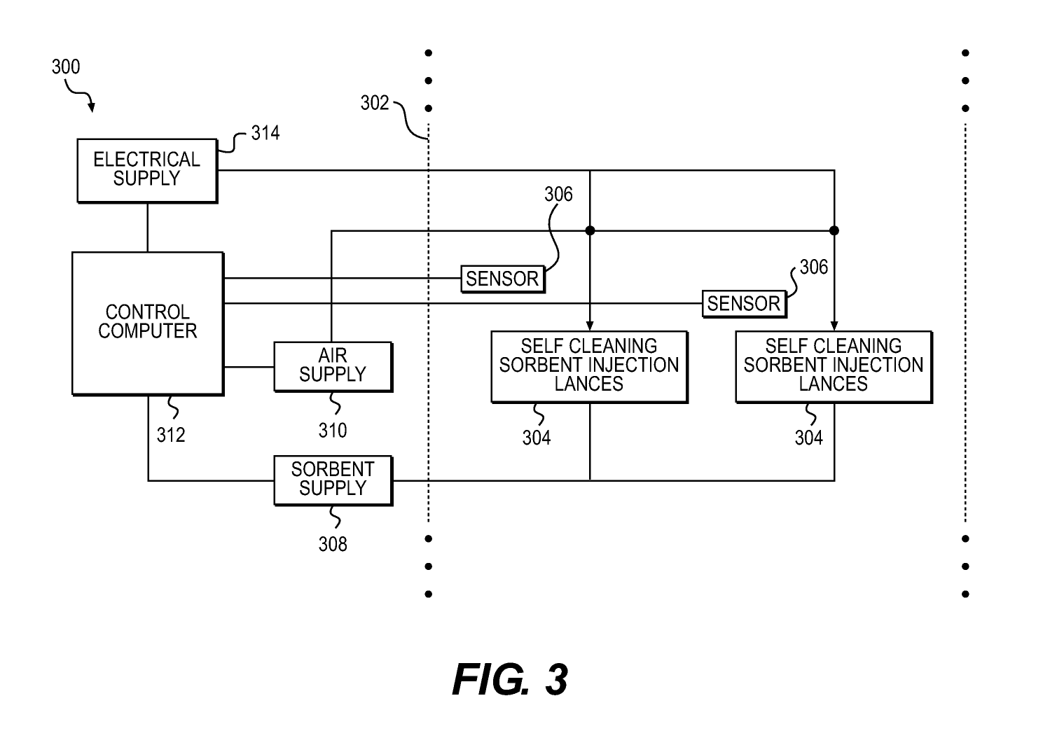

With reference now to FIG. 3, shown is a system 300 diagram illustrating system utilizing self-cleaning sorbent injection lance. System 300 includes flue-gas duct 302, a plurality of self-cleaning sorbent injection lances 304 and sorbent flow sensors 306 installed therein, sorbent powder supply 308, compressed air supply 310, control computer 312 and electrical supply 314. As described above, control computer 312 may be overall flue gas treatment system control computer. Control computer 312 may control self-cleaning of self-cleaning sorbent injection lances 304 as described above. Control computer 312 may read sensors to determine flow-rate of sorbent through lances 304, as described above. Control computer 312 may activate electrical supply 314 to operate air control valve of self-cleaning sorbent injection lances 304 to provide compressed air from compress air supply 310, as described above. Likewise, control computer 312 may activate and de-activate sorbent supply to lances 304, as described above.

The terms and descriptions used herein are set forth by way of illustration only and are not meant as limitations, Those skilled in the art will recognize that many variations are possible within the spirit and scope of the invention as defined in the following claims, and their equivalents, in which all terms are to be understood in their broadest possible sense unless otherwise indicated.

1. A self-cleaning sorbent injection lance, comprising:
a lance arm, through which sorbent material passes;
a lance outlet, connected to sorbent arm, through which sorbent material is output from the self-cleaning sorbent injection lance, wherein lance arm and lance outlet may get clogged with sorbent material while in operation;
a sorbent inlet, connected to the lance arm, that provides sorbent material to the self-cleaning sorbent injection lance;
an air control valve, connected to the lance arm, through which compressed air may be supplied to the self-cleaning sorbent injection lance for cleaning clogged sorbent material; and
an electrical valve control, connected to the air control valve, that opens the air control valve when receiving an electrical signal so that compressed air is supplied to lance arm and lance outlet of self-cleaning sorbent injection lance whereby the self-cleaning sorbent injection lance may be cleaned and sorbent material clogs removed without taking the self-cleaning sorbent injection lance off-line.

2. The self-cleaning sorbent injection lance of claim 1 wherein the electrical valve control includes a electric solenoid connected to the air control valve and an electrical supply to activate the electric solenoid.

3. The self-cleaning sorbent injection lance of claim 1 wherein the air cont valve includes a diaphragm-type valve.

4. The self-cleaning sorbent injection lance of claim 1 wherein the sorbent inlet Includes a valve.

5. The self-cleaning sorbent injection lance of claim 1 wherein the lance arm is angled downward so that the lance outlet is semi-perpendicular to lance arm.

6. A system utilizing a self-cleaning sorbent injection lance for injecting sorbent into a flue gas duct, comprising:
a flue gas duct, through which flue gas flows;
one or more self-cleaning sorbent injection lances, each lance including:
a lance arm, through which sorbent material passes;
a lance outlet, connected to sorbent arm, through which sorbent material is output from the self-cleaning sorbent injection lance, wherein lance arm and lance outlet may get clogged with sorbent material while in operation;
a sorbent inlet, connected to the lance arm, that provides sorbent material to the self-cleaning sorbent injection lance;
an air control valve, connected to the lance arm, through which compressed air may be supplied to the self-cleaning sorbent injection lance for cleaning clogged sorbent material; and
a electrical valve control, connected to the air control valve, that opens the air control valve when receiving an electrical signal so that compressed air is supplied, to lance arm and, lance outlet of self-cleaning sorbent injection lance whereby the self-cleaning sorbent injection lance may be cleaned and sorbent material clogs removed without taking the self-cleaning sorbent injection lance off-line;
a compressed air supply, connected to the air control valve; and
a control computer, wherein the control computer activates the compressed air-supply and opens the air control valve to provide compressed air to the one or more self-cleaning sorbent injection lances.

7. The system of claim 6 further comprising a sorbent material supply.

8. The system of claim 7 wherein the sorbent material supply includes a pneumatic conveying blower.

9. The system of claim 6 further comprising an electrical supply, wherein the control computer opens the air control valve by causing the electrical supply to provide electricity to the electrical valve control.

10. The system of claim 6 wherein the flue gas duct includes sensors for measuring the flow-rate of sorbent material.

11. A method for operating a self-cleaning sorbent injection lance for injecting sorbent into a flue gas duct, comprising:
supplying sorbent material to a self-cleaning sorbent injection lance;
determining whether to operate self-cleaning on scheduled or as-needed basis;
if operating on scheduled basis, determining if scheduled time has elapsed;
if elapsed, opening air control valve to supply compressed air to the self-cleaning sorbent injection lance for cleaning clogged sorbent material in the self-cleaning lance;
if operating on an as-needed basis, determining whether flow-rate of sorbent material through self-cleaning sorbent injection lance has dropped below pre-determined level;
if flow-rate has dropped below pre-determined level, opening air control valve to supply compressed air to the self-cleaning sorbent injection lance for cleaning clogged sorbent material in the self-cleaning lance;
closing air control valve when flow-rate reaches pre-determined level; and
repeating above steps.
